(19) United States
(12) Patent Application Publication
(10) Pub. No.: US 2007/0121606 A1
(43) Pub. Date: May 31, 2007

(54) VOIP Hub Using Existing Audio or Video Systems

(75) Inventor: Stefan Scheinert, San Jose, CA (US)

Correspondence Address: HOGAN & HARTSON L.L.P., 1999 AVENUE OF THE STARS, SUITE 1400, LOS ANGELES, CA, 90067, US

(73) Assignee: FUN RACQUETS, INC., San Jose, CA (US)

(21) Appl. No.: 11/556,129

(22) Filed: Nov. 2, 2006

Related U.S. Application Data
(60) Provisional application No. 60/732,573, filed on Nov. 3, 2005.

(51) Int. Cl. H04L 12/66

(52) U.S. Cl. 370/356

(57) ABSTRACT

A voice over Internet hub that uses existing audio or video systems to handle phone calls. The hub is linked to the audio system and produces an audio output to the audio system. The audio system may be a stereo system or television. The hub generates audio signals for ring tones, key clicks and voice signals. The hub may also be linked to a video system. The hub is controlled by a remote control unit having a microphone and loudspeaker.

### RELATED APPLICATIONS

This application claims the benefit of priority under 35 USC 119 of U.S. provisional application No. 60/732,573, filed on Nov. 3, 2005, which application is hereby incorporated by reference in its entirety.

### BACKGROUND OF THE INVENTION

1. Field of the Invention

The present invention relates to a VOIP (Voice Over Internet Protocol) hub that uses existing audio systems, such as stereo radio or surround sound systems, or existing video systems, such as television (TV) sets, to handle phone calls.

2. Description of Related Art

Conventional telephone systems are limited to a 64 kb/s data stream that generates poor voice quality in the frequency range from 300 Hz to 3.4 kHz. Furthermore, the connection is limited to a voice only link.

Newer VOIP systems are trying to match the quality seen in conventional systems. However, since VOIP is no longer limited to a 64 kb/s data stream, higher audio quality can be achieved by using so-called WideBand-Codecs (WB-Codecs). These codecs use more bandwidth than NarrowBand Codecs (NB-Codecs), but they achieve higher audio quality. For example, the frequency range is from 50 Hz to 7 kHz, which makes the voice quality superior to that of conventional phone systems.

In the future, it is expected that more advanced WB-Codecs will be defined that achieve even better audio quality, such as up to MP3 quality and/or stereo capabilities. In the past, WB-Codecs were not feasible because either the bandwidth requirements on the Internet were too high or the controller was not powerful enough to process the data compression for voice.

VOIP systems can add short messages (SMS) and multi media messages (MMS), which are currently being used in mobile systems.

Once the bandwidth on the Internet is “big enough” video signals may be added, so a connection could carry voice and video (video telephone) signals.

Current VOIP systems use NB-Codecs with voice only. This is how VOIP devices can convert the signal into an RJ-11 signal, which then is connected to a regular phone.

However, regular phones cannot support newer VOIP features like video, SMS, MMS, and higher audio quality.

### SUMMARY OF THE INVENTION

The present invention addresses the issue of defining new devices for this new generation of telephone systems and provides a VOIP hub and a remote control with a microphone.

The VOIP hub is connected to the Internet through either an Ethernet link or a wireless link, such as 802.11 like g, n, a or ultra wideband (UWB), and includes all the logical functions for the VOIP protocol. It includes a controller and handles call control, such as originating and terminating telephone calls and optional SMS and MMS messages. The VOIP hub generates outputs for audio and optional video. The audio output is used to generate ring tones, key clicks, voice signal, and audio clips from MMS messages. The audio output can be connected to an existing device such as a stereo radio, TV, surround sound system, etc.

Another embodiment of the invention generates a video output at the VOIP hub so that it can be connected to a TV for display purposes such as displaying SMS or MMS messages, playing video clips, displays for user interfaces, and video telephones.

Another embodiment of the invention integrates the VOIP hub into a TV set, surround sound system or stereo system. This is especially beneficial when the other device already requires an Internet connection, e.g. an Internet radio or Internet TV.

The VOIP hub is controlled by a remote control. The remote control is also used for call control such as dialing telephone numbers or IP addresses and can accept or terminate calls. The remote control has either an integrated microphone for VOIP calls or a separate microphone device linked directly to the VOIP hub.

Another embodiment of the invention integrates a video camera into the remote control for video calls. The camera is either a separate device or is integrated into the TV display chassis or VOIP hub.

The link between the VOIP hub and remote control is wireless. Bluetooth, Zigbee and other 802.xx standards can be used that offer high enough data rates for the microphone and the optional loudspeaker in the remote control. Another option is optical links, e.g. infrared, if the remote is intended to stay in the same room as the VOIP hub.

Another embodiment integrates a loudspeaker on the other side of the remote control, so the user has privacy or can even leave the room without disconnecting the call.

The VOIP hub or the remote control can mute the current audio signal (e.g. TV or radio) when a call is coming in. If the VOIP hub is connected to a display the caller ID can be displayed to indicate the incoming call. When the system is in standby mode (no audio or video signals), the VOIP hub or the VOIP remote control activates the audio and/or video path of the audio or video system to indicate the incoming call.

When the audio and/or video system uses other remote controls, the VOIP remote control unit can learn the functions to switch on the device and select the right audio or video channel to handle the VOIP call. In this case, no modifications are needed in the existing audio or video system. The system is switched off and an incoming or outgoing call activates the system, which handles the call.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a diagram of an audio only VOIP hub and a remote control according to the present invention.

FIG. 2 is a diagram of an embodiment of the invention offering video signals.

FIG. 3 is a diagram of a remote control according to the invention.

FIG. 4 is a diagram of a multi-unit configuration for multiple rooms according to the invention.

### DETAILED DESCRIPTION OF THE INVENTION

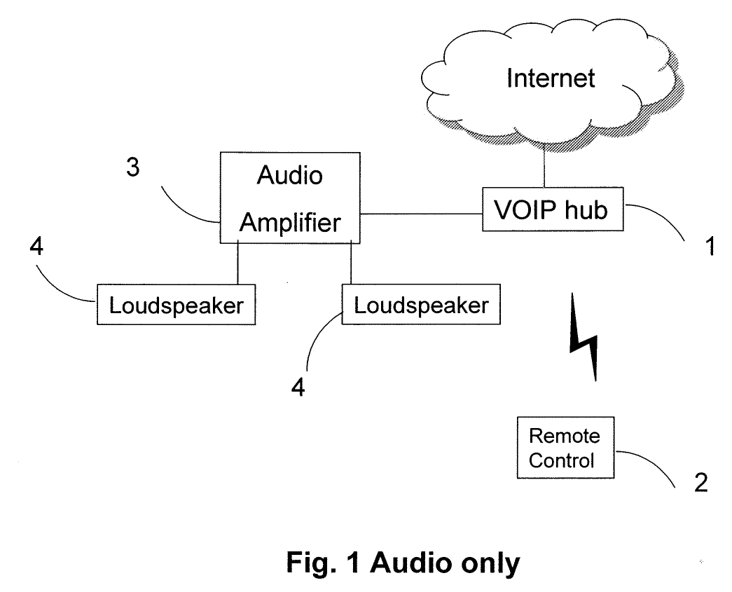

FIG. 1 is a diagram of a VOIP hub 1 according to the present invention. VOIP hub 1 is connected to audio amplifier 3, which controls audio channels, such as a source of input and loudspeakers 4. VOIP hub 1 is linked to the Internet so that it can receive or originate calls through the Internet. VOIP hub 1 is controlled by VOIP-remote control 2, which includes keys as in a mobile phone. These keys can be used to enter a telephone number, start/off hook, stop/on hook, control volume, etc. Additional functions such as microphone selection when multiple microphones are available in the room may also be provided.

If a call is coming in, amplifier 3 is switched on, the right audio source (VOIP-phone) is selected and the volume is set. VOIP hub 1 generates a ring tone, and loudspeakers 4 play the ring tone. A simple ring tone or audio clips can be used to indicate an incoming call.

A user accepts the call by pressing a button such as “Send/Off hook” (sometimes also called “green” or “yes” button). As soon as the call is accepted, the ring tone stops, the microphone is activated and the other person is heard through loudspeaker 4. The user is heard through a microphone.

When the user presses a button such as “Stop/on hook” (sometimes called “red” or “no” button) the call is terminated.

For an outgoing call, the user enters a telephone number (or an email address or ID number) and presses the “Send/off hook” button. When there is no video output at VOIP hub 1, a display in remote control 2 displays the number so that the right number can be verified. VOIP hub 1 generates a key click for better feedback to the user.

Remote control 2 activates amplifier 3, selects the right audio source, sets the volume and generates a ring tone.

When the other party picks up the phone, the ring tone is stopped and the user can hear the other party.

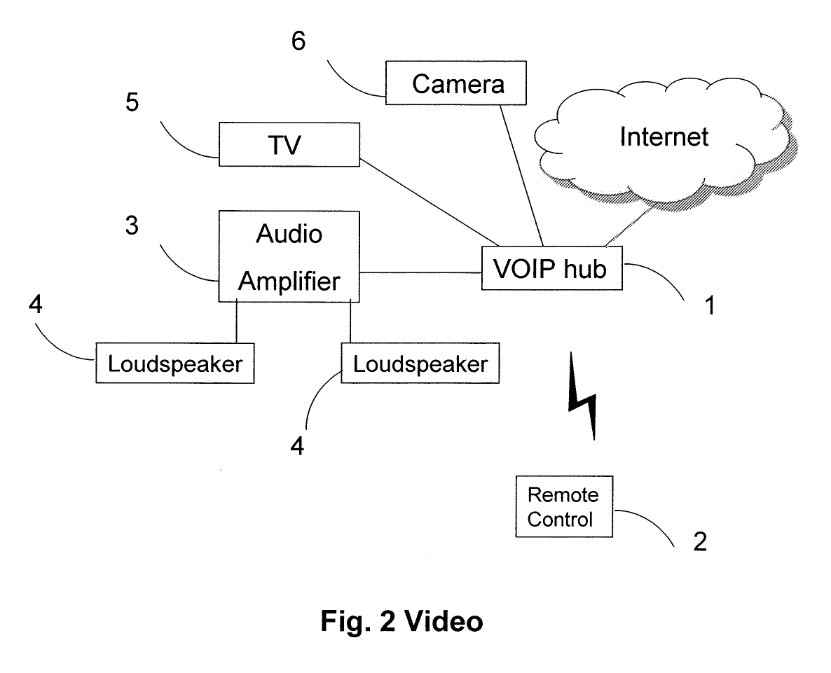

FIG. 2 shows an audio system with a video system 5, such as a TV. TV 5 is used to display incoming calls, give optical feedback for the keys of VOIP remote control 2, SMS or MMS messages, video clips and video telephone signals.

The procedures are the same as described for FIG. 1 except that VOIP hub 1 handles video as well.

Camera 6 generates a video signal for a video telephone call. Camera 6 is either integrated into the display chassis, which brings a good performance, is provided as a separate device, or is integrated into remote control 2.

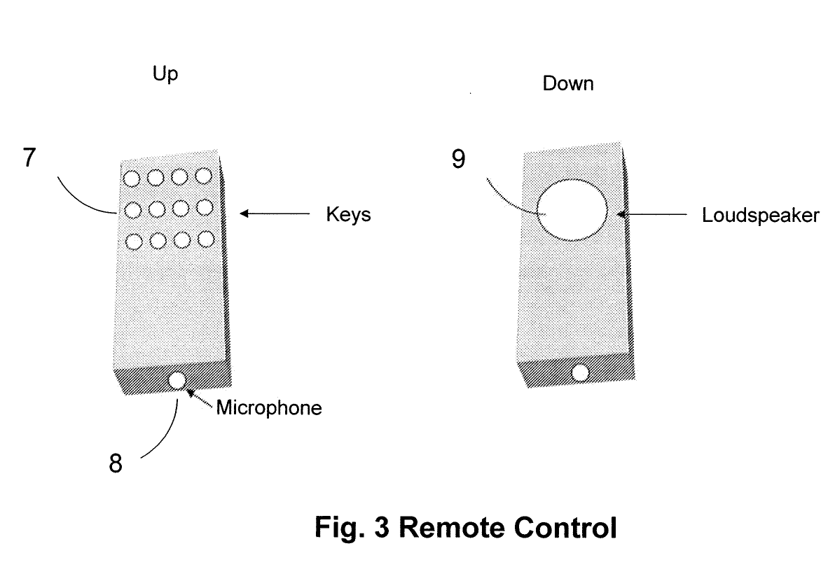

FIG. 3 shows VOIP remote control 2 with keys 7 at a top side and microphone 8 at the other (back) side, typically facing the user. In this manner, feedback from microphone 8 to the loudspeaker is less likely and loudspeaker volume can be higher before feedback noise is noticed.

At the bottom side a loudspeaker/earphone 9 is integrated. If the user does not want to use the loudspeakers of the audio system during a telephone call, he/she presses a key to deactivate the audio system loudspeakers and the audio is routed to VOIP-remote loudspeaker 9. The user can then continue the call on a more private basis on remote control 2. Alternatively, a sensor on the remote may disable earphone 9 if remote control 2 is placed on a table and activate earphone 9 and disable the loudspeakers 4 if remote 2 is picked up. This sensor removes the n necessity of pressing a button, and may also be used to determine on hook/off hook status.

Since the remote control transmits audio data to VOIP hub 1 and may receive audio signals from VOIP hub 1, a wireless link may be used. Bluetooth is one suitable option and provides the bandwidth needed to transmit all data to and from remote unit 2. Other standards can be used as well, such as other 802.11.xx or UWB which provides even higher bandwidth for video, so that a camera may be integrated into remote control 2 or the camera could be a stand alone unit controlled by VOIP hub 1. In this scenario VOIP hub 1 has two or three RF links: one for VOIP remote 2, another for the stand alone camera and a third for a stand alone microphone.

Another embodiment of the invention integrates the microphone into the stand alone camera. A small display may optionally be integrated in additional devices.

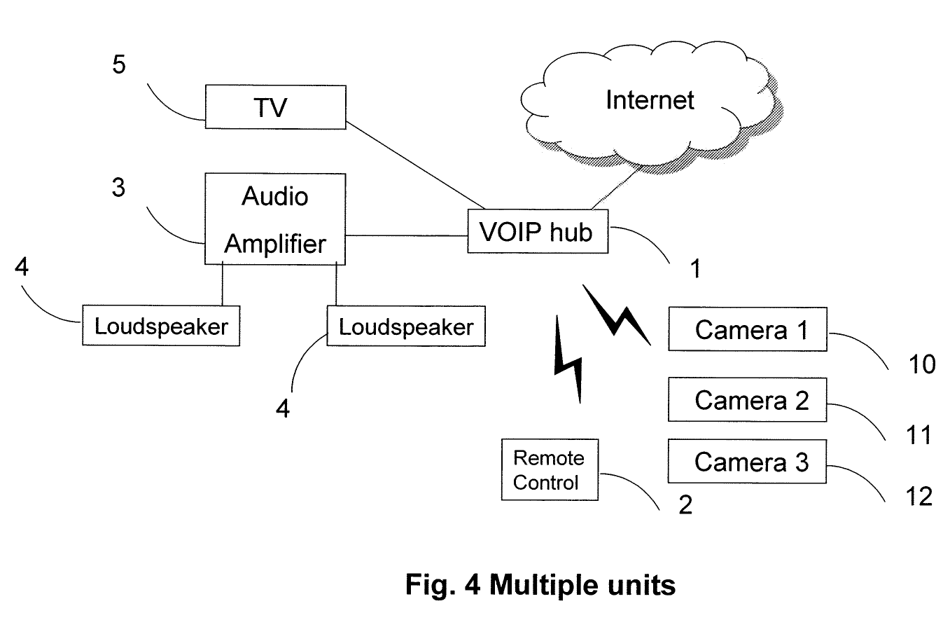

FIG. 4 shows a configuration with three cameras. Camera 10 is in the same room as TV 5. Cameras 11 and 12 are in different rooms and have loudspeaker, camera and display integrated. Each camera has an integrated microphone.

VOIP hub 1 automatically switches the camera devices based on, for example, the volume of the speaking person. VOIP hub compares the volumes of the speaker and switches the signal to the corresponding unit. When a person starts a telephone call in room one with camera 10, for example, then walks to room two, VOIP hub 1 then detects stronger signals coming from room two and switches audio and video signals to camera 11 in room two.

The particular embodiments of the invention described in this document should be considered illustrative, rather than restrictive. Modification to the described embodiments may be made without departing from the spirit of the invention as defined by the following claims.

1. A VOIP hub linked to an audio system wherein the hub is linked to the Internet and produces an audio output to an audio system.

2. A VOIP hub as claimed in claim 1, wherein the hub is linked through an Ethernet connection or a wireless connection to the Internet.

3. A VOIP hub as claimed in claim 1, wherein the hub is linked through an analog interface to the audio system.

4. A VOIP hub as claimed in claim 1, wherein the hub is linked through a digital interface to the audio system.

5. A VOIP hub as claimed in claim 1, wherein the audio system is a stereo system, a surround sound system or a TV system.

6. A VOIP hub as claimed in claim 1, wherein the hub generates audio signals for ring tones, key clicks and voice signals.

7. A VOIP hub as claimed in claim 1, wherein the hub is linked to a video system.

8. A VOIP hub as claimed in claim 7, wherein the hub generates video signals from video calls and SMS or MMS messages for the video system.

9. A VOIP hub as claimed in claim 1, wherein the hub is a part of a stereo system, surround sound system or TV set.

10. A VOIP hub as claimed in claim 1, wherein the hub is linked to a microphone.

11. A VOIP hub as claimed in claim 1, wherein the hub is linked to a video camera.

12. A system comprising a VOIP hub as claimed in claim 1 and a remote control unit that controls the VOIP hub.

13. A system as claimed in claim 12, wherein the remote control unit contains a microphone.

14. A system as claimed in claim 13, wherein the remote control unit contains a loudspeaker.

15. A system as claimed in claim 12, wherein a link between the remote control unit and the VOIP hub is wireless.

16. A system as claimed in claim 12, wherein a link between the remote control unit and the VOIP hub is optical.

17. A system as claimed in claim 12, wherein the remote control unit also handles volume, power on/off, select audio and a video source of an existing audio or video system.
